(19) United States
(12) Patent Application Publication
(10) Pub. No.: US 2012/0142794 A1
(43) Pub. Date: Jun. 7, 2012

(54) FOAM WITH FILLING

(75) Inventors: Philippe DESBOIS, Edingen-Neckarhausen (DE); Dietrich SCHERZER, Neustadt (DE); Andreas WOLLNY, Ludwigshafen (DE); Andreas RADTKE, Mannheim (DE); Tobias Heinz STEINKE, Speyer (DE)

(73) Assignee: BASF SE, Ludwigshafen (DE)

(21) Appl. No.: 13/307,445

(22) Filed: Nov. 30, 2011

Related U.S. Application Data
(60) Provisional application No. 61/418,905, filed on Dec. 2, 2010.

(51) Int. Cl. C08L 77/02; C08L 61/28; B05D 7/24; C08J 9/42

(52) U.S. Cl. 521/54; 427/230

(57) ABSTRACT

The present invention relates to open-cell foams filled with polyamide and also to a production process therefor.

The present invention relates to open-cell foams filled with polyamide and also to a production process therefor.

There are various known prior art processes composed of polymeric materials for example. An overview of various types of foams is, for example, “Polymeric Foams and Foam Technology”, edited by D. Klempner and V. Sendijarevic, Carl Hanser Verlag, Munich, 2nd edition, 2004. Here “foam” can be defined as a material produced by incorporation of gas bubbles into a liquid or solid.

Open-cell foams are also known in principle. The term “open-cell” defines a foam structure wherein every cell includes at least two pores or destroyed faces. In addition, a majority of cell ribs have to form part of three cells at least. In closed-cell foams, by contrast, the cells do not have any pores or destroyed faces. Open-cell plastics foams are usually produced on the basis of polyethylene (PE), polyurethane (PU) and polyvinyl chloride (PVC), see Arnim Kraatz's thesis, 2007, Halle University). Typically, an open-cell foam tends to be soft.

Open-cell foams can consist of metals or of plastics materials for example.

Processes are described in the prior art for modifying the properties of a thermoplastic or of a thermoset via inclusion of other substances. Examples of processes of this type are mixing with another polymer to form a homogeneous system (e.g., PMMA and PSAN, or PPO and polystyrene—see Modern Styrenic Polymers, John Wiley and Sons, Ltd, 2003, page 699, part 6, Styrenic Blends), adding lubricants to enhance flowability (Plastics Additives Handbook, 5th Edition, Hanser Publishers, Chapter 5, Lubricants), adding glass fibers to enhance stiffness (Handbuch der Technischen Polymerchemie, VCH Verlag, 1993, page 651, part 12.4.5.1, reinforced plastics), and incorporating rubber into a rigid thermoplastic to modify compressive strength and toughness (Mechanical Properties of Polymers Based on Nanostructure and Morphology, Taylor and Francis Publishers, 2005, Chapter 11, Structure-Property Relationships in Rubber Modified Amorphous Thermoplastic Polymers.

Inclusion of other substances, for example polymers, in a polymeric foam can often provide a mutual improvement in the mechanical properties of the various components, i.e., the foam and the polymeric substance included in the foam (reinforcing effect). In some cases, for example, melting of the foam at low temperatures is prevented or flame resistance is improved.

Existing processes, which are mostly injection-molding processes, are incapable of providing an interpenetrating network of a foam with polymers, since the viscosity of polymers is generally too high. The pores of a foam can only be filled incompletely with a polymer, if at all, using existing processes. Moreover, attempts to fill the pores of a foam will often damage or destroy the foam.

It is an object of the present invention to provide a process for filling the pores of an open-cell foam with a polymer as completely as possible without damaging the foam in the attempt. This should provide a composite material having improved properties, for example improved mechanical properties, such as toughness, extensibility and recovery after compression.

We have found that this object is achieved, surprisingly, by the catalyzed anionic polymerization of lactam monomers in the presence of open-cell foams.

The present invention accordingly provides a process for producing a composite material comprising drenching an open-cell foam (S) at least in part with at least one monomer (M) from the group of lactams and then polymerizing the monomer (M) at least partially anionically using a catalyst.

Further subjects of the present application are a composite material obtainable by the process of the present invention and also the use of a composite material obtainable by the process of the present invention in sports equipment, as a flameproofing element or as a reinforcing element.

In preferred embodiments of the present invention, one of the phases effectuates a positive modification of the other (mutual reinforcing effect). This effect can be exploited, for example for reinforcement, impact modification or improving the breaking extension of a composite material. A further advantage is the reduced water imbibition of the composite material of the present invention compared with conventionally produced composite materials.

The term “composite material” herein refers to an engineering material combining two or more dissimilar constituent materials.

The term “melamine-formaldehyde foam” comprises melamine-formaldehyde condensates which, in addition to melamine, may comprise up to 50% by weight and preferably up to 20% by weight of other compounds, capable of forming heat-curable resins, and which, in addition to formaldehyde, may comprise up to 50% by weight and preferably up to 20% by weight of other aldehydes as co-condensed units.

However, the use of an unmodified melamine-formaldehyde condensate is preferred according to the present invention.

Examples of other compounds capable of forming heat-curable resins are melamine substituted by alkyl, urethanes, aliphatic amines, phenol and phenol derivatives. Examples of useful aldehydes are acetaldehyde, acrolein and benzaldehyde.

Further details concerning melamine-formaldehyde condensates are discernible from Houben-Weyl, Methoden der organischen Chemie, volume 14/2, 1963, page 319 to 402.

The molar ratio of compound capable of forming heat-curable resin to aldehyde can be varied within wide limits from 1:1.5 to 1:4.5; in the case of melamine-formaldehyde condensates it is preferably in the range from 1:2.5 to 1:3.5.

The melamine resins advantageously comprise co-condensed sulfite groups. Further details concerning melamine-formaldehyde condensates are also discernible from U.S. Pat. No. 4,540,717.

After the process of the present invention, the foam and the polyamide each form a continuous phase. Thus, at the end of the process, the system comprises at least two co-continuous phases, or at least two main phases. It is believed that the morphology of the composite material of the present invention is mainly determined by the pore size.

Specifically, the process of the present invention is carried out as follows. The foam therein is preferably dry.

The foam (S) is contacted with a mixture, for example a solution comprising monomer (M), catalyst and optionally activator. This can be accomplished for example by dipping the foam into a solution of monomer (M), catalyst and optionally activator, or by spraying the foam (S) with this solution, or by brushing the foam with the solution. This step is preferably carried out under reduced pressure.

The temperature for the subsequent polymerization is generally in the range from 85° C. to 200° C., preferably in the range from 95° C. to 180° C. and more preferably in the range from 105° C. to 160° C.

The monomer (M) may be situated exclusively in the pores of the foam (S). However, it can also be advantageous to have a thin polymeric film on the surface of the foam (S) and hence of the composite (W).

The ratio of foam (S) to monomer (M) can be varied. The ratio is generally in the range from 90:10 to 10:90, preferably in the range from 80:20 to 20 to 80 and more preferably in the range from 60:40 to 40:60.

According to the present invention, the foam may consist for example of metal, plastic or of a natural product such as wood (balsa wood for example). The foam may also consist of mixtures of these materials.

In a preferred embodiment, the foam consists of metal or of mixtures of plastic with metal. Metals from the group comprising aluminum and magnesium are preferred.

In a further preferred embodiment, the foam consists of plastic.

Examples of plastics capable of forming suitable foams are PSU (polysulfone), PEI (polyetherimide), PI (polyimide), polyurethanes, PA (polyamide), PLA (polylactide), PPE/PS (polyphenylene ether/polystyrene), amsan (acrylonitrile/alpha-methylstyrene), PC (polycarbonate), polypropylene, melamine-formaldehyde.

Particular preference is given to melamine-formaldehyde foam, for example Basotect® from BASF SE.

According to the present invention, the foam should be thermally stable up to 90° C., preferably up to 105° C. and more preferably up to 130° C.

The foam may have a regular or irregular pore structure. An example of the latter is a honeycomb structure that occurs in beehives for example. This structure usually possesses a hexagonal pore structure.

Monomer (M) is a compound from the group of lactams. Examples thereof are caprolactam, piperidone, pyrrolidone, laurolactam or mixtures thereof, preferably caprolactam, laurolactam or mixtures thereof and more preferably caprolactam or laurolactam.

Useful catalysts include inter alia sodium caprolactamate, potassium caprolactamate, bromide magnesium caprolactamate, chloride magnesium caprolactamate, magnesium biscaprolactamate, sodium hydrides, sodium metal, sodium hydroxide, sodium methoxide, sodium ethoxide, sodium propoxide, sodium butoxide, potassium hydride, potassium metal, potassium hydroxide, potassium methoxide, potassium ethoxide, potassium propoxide and potassium butoxide, preferably sodium hydrides, sodium metal, sodium caprolactamate and more preferably sodium caprolactamate (e.g., Bruggolen® C 10, a solution of 18% by weight of sodium caprolactamate in caprolactam).

A preferred embodiment of the present invention utilizes at least one activator (also known as an initiator). However, it is not absolutely necessary to use an activator.

Useful activators include inter alia aliphatic diisocyanates such as butylene diisocyanate, hexamethylene diisocyanate, octamethylene diisocyanate, decamethylene diisocyanate, undodecamethylene diisocyanate, dodecamethylene diisocyanate, or else aromatic diisocyanates such as toluyl diisocyanate, isophorone diisocyanate, 4,4′-methylenebis(phenyl isocyanate), 4,4′-methylenebis(cyclohexyl isocyanate) or polyisocyanates such as isocyanates of hexamethylene diisocyanate, Basonat® HI 100 from BASF SE, allophanates such as ethyl allophanate or mixtures thereof, preferably hexamethylene diisocyanate, isophorone diisocyanate, and more preferably hexamethylene diisocyanate. Useful activators further include acyl halides or any reaction products of acyl halides or isocyanates with lactams.

The molar ratio of lactam to catalyst can be varied within wide limits, and is generally in the range from 1:1 to 10 000:1, preferably in the range from 10:1 to 1000:1 and more preferably in the range from 50:1 to 300:1. The molar ratio of activator to catalyst can be varied within wide limits, and generally is in the range from 100:1 to 1:10 000, preferably in the range from 10:1 to 1:100 and more preferably in the range from 1:1 to 1:10.

On completion of the process according to the present invention, i.e., after the polymerization of monomer (M) has ended, the composite material can be optionally also postformed, for example by heating and bending.

The composite material obtainable by the process of the present invention is very useful inter alia as a flameproofing element or reinforcing element, for example in automotive construction, or in sports equipment.

### EXAMPLES

The examples which follow serve to illustrate some aspects of the present invention. They should in no way be deemed to restrict the scope of the invention. All components and apparatus items were dry.

### Example 1

A foam composed of Basotect® (a flexible, open-cell foam of melamine resin) measuring 55×20×95 mm³ was laid into a dish formed from aluminum foil and measuring 65×30×105 mm³. The dish was placed for several hours into a drying cabinet at 150° C. under nitrogen.

The following solutions were prepared separately in two glass flasks under nitrogen:

1: 38.45 g of caprolactam+11.55 g of Bruggolen® C10 (a catalyst for preparing polyamide from Brüggemann; 17% of sodium caprolactam in caprolactam)

2: 44.89 g of caprolactam+5.11 g of Bruggolen® C20 (an activator for preparing polyamide from Brüggemann; 80% blocked diisocyanates in caprolactam),

and melted by means of a magnetic stirrer. At 110° C. solutions 1 and 2 were mixed, commixed for 15 seconds and then added to the aluminum dish in the drying cabinet under N₂ until the dish was full. Excess liquid was removed by briefly shaking. After 10 minutes the polymerization had ended. The aluminum dish was taken from the drying cabinet and cooled. The molded article was removed from the aluminum dish. It consisted of an interpenetrated network of foam (Basotect® of BASF) filled with polycaprolactam. VN (viscosity number)=180, residual caprolactam=1.9% by weight
The density of the molded article was 1.1 g/mL.

### Example 2

An open-cell foam of polyamide (PA) measuring 55×20×95 mm³ was put into a glass flask. The flask was evacuated for several hours at 150° C.

The following solutions were prepared separately in two glass flasks under nitrogen:

1: 38.45 g of caprolactam+11.55 g of Bruggolen® C10

2: 44.89 g of caprolactam+5.11 g of Bruggolen® C20,

and melted by means of a magnetic stirrer. At 110° C. solutions 1 and 2 were mixed, commixed for 15 seconds and then added to the PA foam via a valve. After 10 minutes the polymerization had ended.

A microscopic cross section through the foam showed that there was an interpenetrating network.

Before and after the treatment with the caprolactam monomer, the foam was immersed in water for 30 minutes in each case. It was found that water imbibition was distinctly higher before the treatment than after.

Similarly, the stiffness of the foam was distinctly higher after the caprolactam polymerization than before.

We claim:

1. A process for producing a composite material comprising drenching an open-cell foam (S) at least in part with at least one monomer (M) from the group of lactams and then polymerizing the monomer (M) at least partially anionically using a catalyst.

2. The process according to claim 1 wherein the foam (S) consists of plastic and/or metal.

3. The process according to claim 1 or 2 wherein the foam (S) is a melamine-formaldehyde foam.

4. The process according to any one of claims 1 to 3 wherein the monomer (M) is selected from the group comprising caprolactam, piperidone, pyrrolidone, laurolactam and mixtures thereof.

5. The process according to any one of claims 1 to 4 wherein the catalyst is selected from the group comprising sodium caprolactamate, potassium caprolactamate, bromide magnesium caprolactamate, chloride magnesium caprolactamate, magnesium biscaprolactamate, sodium hydrides, sodium metal, sodium hydroxide, sodium methoxide, sodium ethoxide, sodium propoxide, sodium butoxide, potassium hydride, potassium metal, potassium hydroxide, potassium methoxide, potassium ethoxide, potassium propoxide and potassium butoxide.

6. The process according to any one of claims 1 to 5 wherein the anionic polymerization utilizes an activator.

7. The process according to any one of claims 1 to 6 wherein the foam has a honeycomb structure.

8. A composite material obtainable by the process of any one of claims 1 to 7.

9. The use of a composite material obtainable by the process of any one of claims 1 to 7 in sports equipment, as a flameproofing element or as a reinforcing element.
